(19) United States
(12) Patent Application Publication
(10) Pub. No.: US 2011/0283711 A1
(43) Pub. Date: Nov. 24, 2011

(54) GAS TURBINE COMPONENT AND A GAS TURBINE ENGINE COMPRISING THE COMPONENT

(75) Inventors: Kjell Petersson, Trollhattan (SE); Gunnar Marke, Trollhattan (SE)

(73) Assignee: Volvo Aero Corporation, Trollhattan (SE)

(21) Appl. No.: 12/999,633

(22) PCT Filed: Jun. 17, 2008
(86) PCT No.: PCT/SE08/00403

§ 371 Date: Feb. 11, 2011

(51) Int. Cl. F02C 7/20

(52) U.S. Cl. 60/796

(57) ABSTRACT

A gas turbine component includes an element having a relatively weak region with regard to stress loads in operation, the component including at least one elongated stiffening structure which extends on at least one side of the weak region, and the elongated stiffening structure is connected to the element in a load-transmitting manner and adapted to form a load path in its extension direction.

### BACKGROUND AND SUMMARY

The present invention relates to a gas turbine component comprising an element, which has a relatively weak region with regard to stress loads in operation. The invention is further directed to a gas turbine engine, and especially to an aircraft engine, comprising the component. Thus, the invention is especially directed to a jet engine.

Jet engine is meant to include various types of engines, which admit air at relatively low velocity, heat it by combustion and shoot it out at a much higher velocity. Accommodated within the term jet engine are, for example, turbojet engines, turbofan and turboprop engines. The invention will below be described for a turbofan engine, but may of course also be used for other engine types.

Flat parts, such as jackets in gas turbine engine components, are often provided with a geometric change, such as a hole, which defines a weak region in the part due to stress concentrations. It is known to reinforce these parts around the hole with extra material in the form of so-called bosses. Such a boss may be casted as an integral part of the component, or added subsequently by welding, material deposition or other techniques. Such a boss results in a change in the direction of the load path in operation, which in turn leads to an increased global stress in the region.

It is desirable to achieve a gas turbine component, and especially an intermediate compressor structure or frame, which is more cost-efficient in production while maintaining or improving its operational characteristics.

According to an aspect of the present invention, a component comprises at least one elongated stiffening means, which extend on at least one side of the weak region, and that the elongated stiffening means is connected to the element in a load-transmitting manner and adapted to form a load path in its extension direction.

This solution creates conditions for directing the load paths via the elongated stiffening means past the weak region. The elongated stiffening means has no stress concentration factors in the area of the weak region since the direction of the load path will not change and a global stress for the total region (weak region+the elongated stiffening means) will be decreased.

Further, the weak region is preferably dimensioned so that the stress concentration factor of a hole multiplied by a nominal stress is lower in the weak region compared to the reinforced region.

According to a preferred embodiment, one elongated stiffening means extend on either side of the weak region. In this way, the portion between the elongated stiffening means may be produced in a more efficient manner, for example by using thin sheet and avoiding expensive subsequent treatments (for example milling).

Other advantageous features and functions of various embodiments of the invention are set forth in the following description.

### BRIEF DESCRIPTION OF THE DRAWINGS

The invention will be explained below, with reference to the embodiment shown on the appended drawings, wherein

FIG. 1 is a schematic side view of the engine cut along a plane in parallel with the rotational axis of the engine,

FIG. 2 is a partly cut, perspective view of a component i from FIG. 1,

FIG. 3 is a partly cut, perspective view of a part of the component in FIG. 2, and

FIG. 4 is a schematic perspective view showing the load paths resulting from a stress load applied to the component in FIG. 2.

### DETAILED DESCRIPTION

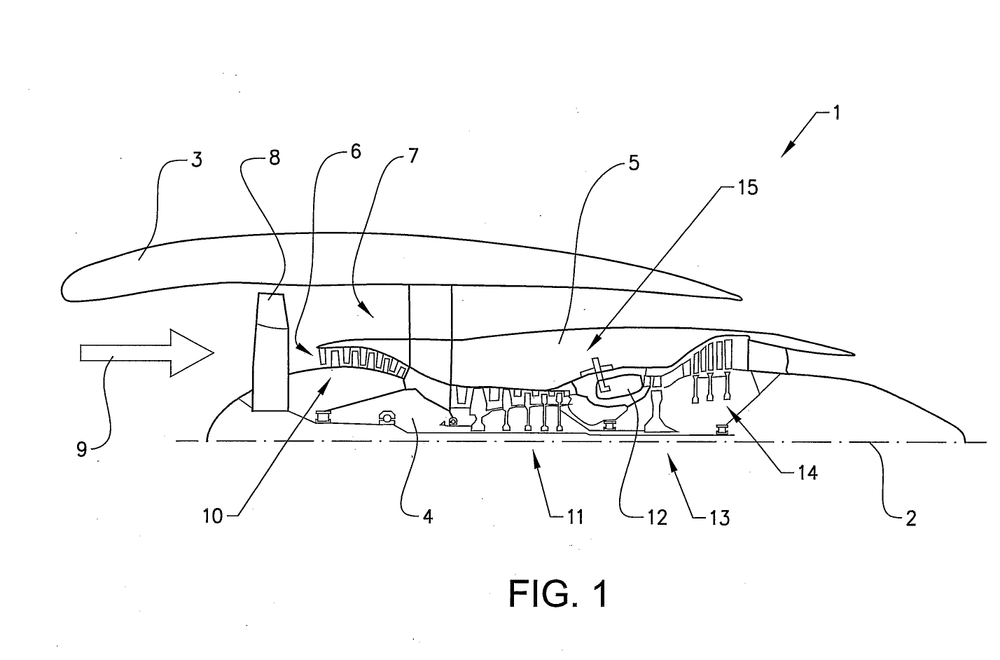

The invention will below be described for a two-shaft turbofan gas turbine aircraft engine 1, which in FIG. 1 is circumscribed about an engine longitudinal central axis 2. The engine 1 comprises an outer casing or nacelle 3, an inner casing 4 (rotor) and an intermediate casing 5 which is concentric to the first two casings and divides the gap between them into an inner primary gas channel 6 for the compression of air and a secondary channel 7 in which the engine bypass air flows. Thus, each of the gas channels 6,7 is annular in a cross section perpendicular to the engine longitudinal central axis 2.

The engine 1 comprises a fan 8 which receives ambient air 9, a booster or low pressure compressor (LPC) 10 and a high pressure compressor (HPC) 11 arranged in the primary gas channel 6, a combustor 12 which mixes fuel with the air pressurized by the high pressure compressor 11 for generating combustion gases which flow downstream through a high pressure turbine (HPT) 13 and a low pressure turbine (LPT) 14 from which the combustion gases are discharged from the engine.

A high pressure shaft joins the high pressure turbine 13 to the high pressure compressor 11 to substantially form a high pressure rotor. A low pressure shaft joins the low pressure turbine 14 to the low pressure compressor 10 to substantially form a low pressure rotor. The low pressure shaft is at least in part rotatably disposed co-axially with and radially inwardly of the high pressure rotor.

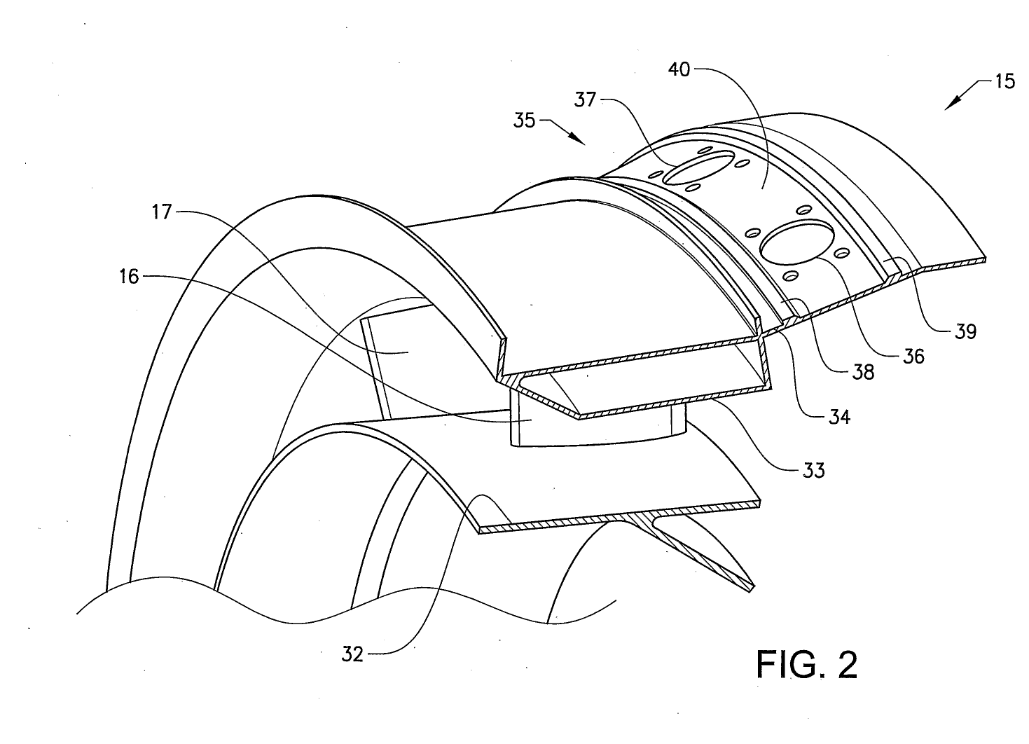

A component, or structure, 15, see FIG. 2, is arranged in connection with the combustor 12. The component 15 comprises a plurality of circumferentially spaced radial vanes 16,17.

FIG. 2 shows the component 15 in a partly cut, perspective view. The component 15 comprises an inner ring 32, an outer ring 33 and said plurality of circumferentially spaced vanes 16,17 which are rigidly connected to the inner ring 32 and the outer ring 33 forming a load-carrying structure.

The gas turbine component 15 comprises an annular element 35 in the form of a sheet. The annular element 35 has a relatively weak central region 34, which is defined by a plurality of circumferentially spaced sets of holes 36,37. Each set of holes comprises a large central hole and four smaller holes defining the corners of a rectangle around the larger hole. The larger hole is configured for receiving a fuel injector and each of the smaller holes is configured for receiving a bolt for securing the fuel injector to the component 15.

The component 15 comprises two elongated stiffening means 38,39, which extend on each side of the weak region 34. The elongated stiffening means 38,39 extends a distance in the circumferential direction, which at least covers the extension of a set of holes in the circumferential direction. The elongated stiffening means 38,39 is connected to the element 35 in a load-transmitting manner and adapted to form a load path in its extension direction. The two elongated stiffening means 38,39 are arranged in parallel to each other.

Said element 35 comprises an annular surface 40, wherein said elongated stiffening means extend in a circumferential direction of said annular surface. Said annular surface forms a substantially circular shape in a cross section perpendicularly with regard to a central axis of the component 15. The central axis of the component 15 coincides with the engine longitudinal central axis 2 when applied in the engine. The annular surface is preferably arranged in parallel to the inner and outer ring 32,33.

Said at least one elongated stiffening means 38,39 is closed in a circumferential direction of said annular surface. Further, said at least one elongated stiffening means 38,39 is positioned on an outer surface in a radial direction of the element.

Said annular surface 40 extends on both sides of at least one of said elongated stiffening means 38,39. Thus, the elongated stiffening means 38,39 are provided at a distance from an edge of the surface 40.

Each of said elongated stiffening means 38,39 forms an integral part of said element. More specifically, said elongated stiffening means 38,39 is formed by a rib projecting from a surface of said element. The elongated stiffening means 38,39 is preferably straight.

The elongated stiffening means 38,39 is preferably formed when casting the component 15 as an integral part of the component. According to an alternative, the elongated stiffening means 38,39 is formed by metal deposition.

According to a further alternative, the elongated stiffening means 38,39 is formed by a separate part attached to the annular surface 40 subsequent to the formation of the element 35. More specifically, said elongated stiffening means may be formed by a wire applied on the element 35.

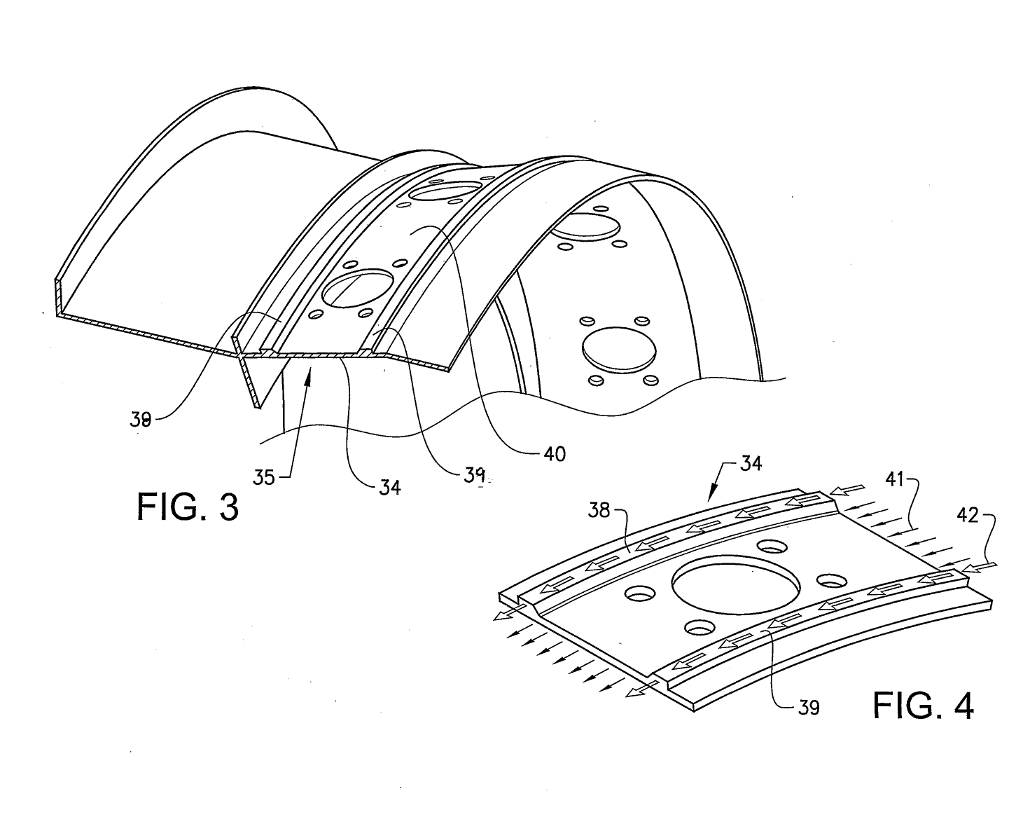

FIG. 3 shows the sheet element 35 in a partly cut perspective view. FIG. 4 shows a section of the element 35 with the stresses applied in the circumferential direction indicated with smaller arrows 41 and the load paths through the elongated stiffening means indicated with larger arrows 42.

The invention is not in any way limited to the above described embodiments, instead a number of alternatives and modifications are possible without departing from the scope of the following claims.

For example, the intermediate compressor structure described above is adapted to transfer loads and form support for bearings. However, the invention may also be applicable in other components of the gas turbine engine, such as in components, which form housings or casings, ie components which are not specifically designed for load transfer and bearing support.

Further, the design of the elongated stiffening means is not limited to form a closed circle. Instead, the elongated stiffening means may form a circumferentially interrupted structure.

Further, the weak region of the element may be formed by a geometric change different from a hole, such as a recess or similar.

The term “annular” is not limited to a circular cross sectional shape. Instead, the term “annular” for example comprises oval, rectangular, or other polygonal shapes.

1. A gas turbine component comprising an element, the element comprises an annular sheet surface which has a relatively weak: region with regard to stress loads in operation, where the component comprises two elongated stiffening means, which extend in a circumferential direction of the annular surface on each side of the weak region, and that the elongated stiffening means are connected to the element in a load-transmitting manner and adapted to form a load path in its extension direction, wherein the annular surface extends on both sides of the elongated stiffening means.

2. A gas turbine component according to claim 1, wherein the two elongated stiffening means are arranged in parallel to each other.

3. A gas turbine component according to claim 1, wherein the annular surface forms a substantially circular shape in a cross section.

4. A gas turbine component according to claim 3, wherein the at least one elongated stiffening means is closed in a circumferential direction of the annular surface.

5. A gas turbine component according to claim 3, wherein the at least one elongated stiffening means is positioned on an outer surface in a radial direction of the element.

6. A gas turbine component according to claim 1, wherein at least one of the elongated stiffening means forms an integral part of the element.

7. A gas turbine component according to claim 1, wherein at least one of the elongated stiffening means is formed by a rib projecting from a surface of the element.

8. A gas turbine component according to claim 1, wherein the weak region of the element comprises at least one recess and/or a through-hole and that the elongated stiffening means extends a distance covering at least the extension of the recess/hole.

9. A gas turbine component according to claim 1, wherein the component comprises a plurality of circumferentially spaced vanes and that the element is mechanically connected to the vanes.

10. A gas turbine component according to claim 9 wherein the component comprises an inner ring and an outer ring and that the vanes are rigidly connected to the inner ring and to the outer ring.

11. A gas turbine component according to claim 9, wherein the element is positioned on a radial outer side of the vanes.

12. A gas turbine component according to claim 1, wherein the element is circumferentially closed.

13. A gas turbine component according to claim 1, wherein the component is configured for being used as an intermediate frame in a gas turbine engine.

14. A gas turbine engine comprising a gas turbine component according to claim 1.
